(19) United States
(12) Patent Application Publication
(10) Pub. No.: US 2017/0246789 A1
(43) Pub. Date: Aug. 31, 2017

(54) EXTRUDER, PLASTIC MOLDING PLANT OR COMPOUNDING PLANT AND METHOD FOR OPERATING SUCH A PLANT

(71) Applicant: Reifenhäuser GmbH & Co. KG Maschinenfabrik, Troisdorf (DE)

(72) Inventors: Peter SIEBIGTEROTH, Eitorf (DE); Patrick MICHELS, Bonn (DE); Tim Carsten POHL, Koln (DE); Raphael HERMES, Bonn (DE); Jan JACOBI, Neunkirchen-Seelscheid (DE)

(21) Appl. No.: 15/420,639

(22) Filed: Jan. 31, 2017

(30) Foreign Application Priority Data
Feb. 29, 2016 (DE) 10 2016 002 967.6

(51) Int. Cl. B29C 47/92; B29B 7/72; B29C 47/88; B29C 47/08; B29C 47/40; B29B 7/48; B29C 47/00

(52) U.S. Cl. CPC B29C 47/92; B29B 7/489; B29B 7/728; B29C 47/0021; B29C 47/0801; B29C 47/0838; B29C 47/40; B29C 47/884; B29C 2947/92038; B29C 2947/92361; B29C 2947/92809; B29C 2947/92857

(57) ABSTRACT

An extruder, such as a double-screw extruder includes a double cylinder and a double-lead screw arranged therein with a drive train for the screw. The drive train has a coupling with the screw. The extruder includes a sensor for recording a moment load having torque and/or bending moment and for generating electronic data from the recorded moment load. A controller is provided in operative connection to a drive for the drive train and the sensor is in data connection with the controller. The controller is adapted to evaluate the data on the recorded moment load and to trigger a protective action if a threshold value set in the controller is exceeded. The evaluation includes a bending moment calculation. A plastic molding plant produces a film with the extruder along with a nozzle unit and a cooling and wind-up unit or a compounding plant. A method for operating such a plant for manufacturing a film includes the extruder.

### CROSS-REFERENCE TO RELATED APPLICATIONS

This application is related to and claims the benefit of German Patent Application No. 10 2016 002 967.6, filed on Feb. 29, 2016, the contents of which are hereby incorporated by reference in their entirety.

### TECHNICAL FIELD

The disclosure relates to an extruder, a plastic molding plant or a compounding plant and to a method for operating such a plant.

In particular, the disclosure relates to a double-screw extruder, i. e. an extruder with a cylinder, more precisely a double cylinder, and to a double-lead screw arranged therein, and specifically to a plant for manufacturing a film, in particular a blown-film plant or a flat-film line, and to a method for operating such a plant for manufacturing a film.

### BACKGROUND

EP 1 507 182 A1 discloses a method for recognition of wear in extruding plants. For this purpose, a point of reference is determined from a list of relevant machine data, namely conveying behavior, conveying rate, mass throughput, extruder speed, extruder torque, melt pressure and cylinder temperature profile. During operation of the extruding machine, the current measured-value data are compared to the reference point. When a predefined deviation is determined, the disclosure has discovered excessive wear.

DE 10 2007 021 037 B4 also discloses a method for recognition of wear in extruding plants. As an improvement of the method described above and disclosed by the same applicant, a method is introduced which enables an automatic recognition and an early and continuous signaling of the state of wear of the screw and the cylinder. As parameters for this purpose, operating time and the pulse-duty factor of heating and cooling power are mentioned.

DE 10 2011 103 810 A1 discloses a plastification unit with a wear measurement sensor which continuously measures the distance between the screw and the cylinder and calculates the wear from this value.

Other systems for extruders are known from FR 2.148.970, U.S. Pat. No. 4,604,251, US 2002/0083761 A1, DE 44 45 352 C1 of the present applicant or DE 100 48 826 A1, with the last document merely proposing a sensor system for other types of application.

### SUMMARY

The disclosure is based on the task of making an improvement or an alternative available to the state of the art.

In a first aspect of the present disclosure, this task is solved by an extruder having a cylinder and a screw arranged therein, in particular a double cylinder and a double-lead screw arranged therein, and having a drive train for the screw, the drive train for the screw having a coupling and the extruder, in particular the coupling, having a sensor for measuring a moment load comprising torque and/or bending moment and for generating electronic data from the recorded moment loading; a controller being provided which is in operative connection with a drive for the drive train, the sensor being in data connection with the controller and the controller being adapted to evaluate the data on the recorded moment load and to trigger a protective action if a threshold value set in the controller is exceeded, evaluation containing a bending moment calculation.

Regarding terminology, the following explanations are given:

the prototype tests performed by the inventors have taken place on double-screw extruders. In these, the measured values have indicated a correlation with wear. With regard to the basic physical mechanisms assumed by the inventors, one has to proceed on the assumption that the disclosure introduced here is also applicable with other multiple screw extruders.

As a general rule, it is noted that within the framework of the present patent application, indefinite articles and numerals such as “one”, “two” etc. are to be understood as minimum values, i. e. as “at least one . . . ”, “at least two . . . ” etc., unless the context implies to the person skilled in the art, or unless it is explicitly mentioned, that “exactly one . . . ”, “exactly two . . . ” etc. are intended.

The person skilled in the art knows how to adapt the features to different numerical values; i. e. he knows that a single-screw extruder has one real cylinder surface area, but that a double-screw extruder has no two complete cylinders but two interconnected partial cylinder surface areas.

The “drive train” is to be understood as a part of the extruding machine which is driven by a motor, in particular an electric motor. In particular, it can be a shaft or a plurality of shafts with a gear.

The motor itself can be, but does not necessarily have to be part of the drive train.

A “coupling” in the drive train between gear and motor is provided so as to prevent damage to the extruder caused by momentary overload. Thus, for instance, a safety friction clutch can be provided whose sensitiveness can ideally be adjusted, i. e. the moment causing slippage can be changed in quantity. If the rotational resistance at the screw is too high, for instance due to a temperature of the molten mass which is too low, the safety friction clutch can start to slip, preventing a torque overload for the drive train and, for instance, for the screws or the corresponding gear. Naturally, couplings which are not easily reversible are possible as well, for instance shafts connected by a shearing pin or other safety couplings subject to desctruction which require manual intervention to restore the operating mode.

The “sensor” can be a commercial sensor of various types. Normally, the measurement results will be better when a better sensor is used. With very inexpensive sensors, such as wire strain gauges, however, the disclosure can be implemented as well since the basic task includes identifying the correct mechanical parameter and, for operation of the extruder, in evaluating in particular its wear measurement and prognosis.

In accordance with the prototype tests performed by the inventors, the sensor can be attached to the extruder at various sites, but especially at the couplings between screws and gear or directly at the screws or directly at the gear shafts.

The sensor is to be suited for measuring a moment load at the screw or at the coupling leading to the screw or at the drive train; if need be, also at other sites of the extruding machine.

In particular, the sensor is to be suited for measuring a bending moment.

A sensor for measuring a bending moment will normally not determine the bending moment as such but will rather measure a mechanical lengthening or shortening of a component along the rotational axis or parallel to the same. The sensor itself can be adapted to generate electronic data corresponding to the measured values and to transmit the same, or it can be a simple sensor from which, however, data are preferably retrieved electrically, and subsequently electronic data are generated from the retrieved data. For instance, it is good practice to determine the electric resistance of a wire strain gauge and to calculate electronic data from it.

It is pointed out that other measurement methods can be employed as well. The sensor can also use measurement methods which are yet to come.

The “controller” will normally be equipped with a central processing unit (CPU) so as to be able to perform calculation steps independently and also to execute a computer program. Preferably, the controller has a memory for this purpose in which a computer program can be stored.

The controller can be part of the internal hardware or it can be a software solution. The software solution is independent of the location.

Independently thereof, the controller preferably has a memory which it can fill with data itself and/or from which it can read out data.

A signal output of the controller, for instance a switched power output, with or without a cable, is to be operatively connected to the drive for the drive train. This connection can be direct or indirect. It is, for instance, conceivable for the controller to control the drive directly with open-loop or closed-loop control; alternatively or additionally, it can be envisaged for the controller to act on one or more couplings at the extruder, be it for opening and closing the coupling or, for instance, to adjust the sensitivity of a coupling.

A connection to a purely electronic device, such as, for instance, a display, is to be understood in this context as an operative connection to a drive for the drive train.

The sensor is to be in data connection to the controller. In other words, the controller must be able to record the data from the sensor so as to be able to further process the data.

For the sake of operational safety, cable connection means are preferred for the data connection. Wireless connection means, such as, for instance, a radio network or an optical data transmission, are conceivable as well.

The “protective action” to be triggered by the controller can be of a mechanical or of a non-mechanical nature. For instance, the controller can directly intervene in moment loading on the extruder and can, for instance, shut down the drive or make it run more slowly; and/or the controller can act on a coupling; for instance, it can open the coupling or adjusts its sensitivity; and/or the protective action can comprise transmitting a message, for example, on a display of the plant, via a warning light and/or an acoustic signal by the plant and/or via a data connection to a different site, for instance, to a plant management; or, via the Internet or a different data network, to the manufacturer, vendor or service company for the extruder.

The first aspect of the disclosure makes the controller evaluate the electronic data. For this purpose, at least a “bending moment calculation” is to be performed, among other possible processes.

A bending moment calculation can mainly include a bending moment computation, i. e. computation of a bending moment as the final value of the calculation; or an additional calculation can be performed in which a bending moment is only used as an intermediate value of the calculation.

A value which can be converted indirectly into the bending moment can be used as well, for instance, axial elongation or elongation parallel to the axis, or an elongation which has at least one component parallel to the axis of the extruding machine since this elongation can be converted into axial elongation by means of a trigonometric function, which axial elongation can in turn be converted into a bending moment load.

Trials and data evaluation series performed by the inventors have provided the result that indeed there is a correlation between the bending moment and the wear of the screw and/or the cylinder of the extruder. In the inventors' opinion, the calculation method for the bending moment is pioneering because all measured values used up to this point in the state of the art have proved to be unsuitable for predicting wear in the prototype tests carried out by the present inventors.

Other measured variables are basically also suited for evaluating the state of wear of the screw; these variables, however, are influenced by the current operational state of the extruder so that a compensation of the measurement signal which depends on the working point would be necessary to determine the signal component due to wear.

In a preferred embodiment of the disclosure, the extruder is set such that the controller calculates an averaged offset of the bending moment.

The screw in an extruder rotates during operation. Therefore, the bending moment load on a site of the drive transmitting the moment, e. g. on the screw or its coupling, where the coupling can also be an exclusive measurement coupling, is therefore subject to a cyclic behavior. In particular, the bending moment can be determined on a surface of the rotating component, for instance, by means of a wire strain gauge, for instance as a local elongation which is often designated as elongation ε (epsilon) in mechanical engineering.

If the cyclic measured values of the bending moment are plotted over time, this results in a periodic curve which oscillates about a mean value. This value will be called “offset” in the following.

Prototype tests have shown that this offset is substantially altered with increasing wear in the extruder. In a trial for one of the two screws in a double-screw extruder, it has changed from approximately minus 200 Nm to approximately minus 100 Nm.

The amplitude of the oscillations about the offset changes as well in a comparison between the state which is worn-out and the one which is not worn-out. The stronger characteristic alteration, however, has been identified by the inventors in the offset.

Interestingly, the torsional torques have at least approximately stayed the same. The alteration of the relevant characteristic values depends on the raw material which has been processed.

Of course, it is not necessarily the arithmetic average that has to be measured or calculated and then compared. What is crucial is that a characteristic value is used for the periodic curve. For instance, also the local maximum or the local minimum of each cycle or a different value, such as, for instance, the median, can be used.

In other words, it is of decisive importance that according to this advantageous observation made by the inventors, the amplitude of the bending moments' periodic curve does change, but not as much as the offset or in general, the position, while the extruder is subjected to wear.

It has already been pointed out that it can also be advantageous to calculate an amplitude of the bending moment, i. e. the amplitude of the curve which is generated in the bending moment.

According to a second aspect of the present disclosure, the disclosure provides an extruder having a cylinder and a screw arranged therein, in particular having a double-cylinder and a double-lead screw arranged therein, and by a drive train for the screw, the drive train having a coupling with the screw, and the extruder, and in particular the coupling, having a sensor for measuring a moment load including torque and/or bending moment and for generating electronic data from the recorded moment load, a controller being provided which is operatively connected to a drive for the drive train, the sensor being in data connection with the controller and the controller being adapted to evaluate the data on the recorded moment load and to trigger, if a threshold value set in the controller is exceeded, a protective action; evaluation comprising a frequency calculation, in particular, a bending moment frequency calculation.

The prototype tests performed by the inventors have indicated that a frequency calculation can also provide valuable data on wear. In particular, this concerns the frequency of the bending moment. Determining the frequency spectrum can be very useful.

It can also be useful to evaluate the amplitude of the curve together with frequency calculation.

Specifically, it is conceivable to perform several amplitude computations for different frequencies, for instance for a fundamental frequency and for the harmonic multiples of the fundamental frequency, or for several fundamental frequencies and their harmonic multiples.

As a general rule, it is pointed out that whenever a “frequency” is mentioned, a “frequency spectrum” is intended to be disclosed as well.

The “threshold value set in the controller” can be, for instance, a predefined value fixed-programmed by the extruder manufacturer. It can, however, be also a variable value which can be altered either via a data network or by a service technician authorized by the extruder manufacturer; or the value can be set by the user of the machine, for instance so as to approximate the theoretical capacity as far as possible in actual production or, for instance, to maintain a larger safe distance to minimize wear of the extruder as far as possible.

If the threshold value, for instance for a bending moment and/or a torsional moment, is reached or exceeded, the protective action is to be triggered. The protective action can mainly be a braking or stopping of the drive train; that is, this variant would affect the drive. Another possibility is to open the coupling, either mechanically reversibly or mechanically irreversibly, so that manual intervention is necessary to restart the extruder.

As far as the structure of the extruder is concerned, it is preferred for the extruder to have a first coupling and a second coupling between the drive train and the screw, in particular, a safety friction clutch and a measurement coupling, the two couplings being preferably arranged on both sides of a gear, in particular, the safety friction clutch on the drive train side of the gear and the measurement coupling on the screw side of the gear.

Safety friction clutches have already been proven to protect an extruder from excessive moment load. They are normally arranged on the drive side of the gear.

If in addition a coupling is provided which is used for measurement, it is possible to obtain measuring results which are comparable and reproducible to a large degree. In particular, the frequencies which occur in the gear do not affect the measurements quite as strongly. The coupling between the gear and the screw substantially bears the moment loads of the screw.

The gear does not need to be opened even for replacement of a screw. The measurement points at or within the coupling between the gear and the screw can be embodied such that they do not have to be damaged when the screw is replaced.

Based on the idea of bending moment evaluation, the measurement coupling must always be attached between the screw and the driven shaft of the gear, as close to the screw shaft as possible.

The protective action can also be the output of a wear warning, free from mechanical action.

Such a wear warning can be output, for instance, locally at the extruder, for example by means of an optical or acoustic signal. A display can also be used for outputting the wear warning.

Preferably, the controller requests an acknowledgement of the wear warning; with suitable design, however, production can be maintained.

Above all, an authorization can be necessary for acknowledging the wear warning. This can be done, for instance, by authorizing only a limited circle of technical managers of the plant to acknowledge the wear warning. An authorization can take place in various ways which are known in the state of the art.

Alternatively or in addition to a local wear warning at the extruder, the wear warning can be transferred via a data network, preferably to a plant management and/or to the extruder manufacturer.

It is proposed to provide several different threshold values, with the controller being adapted to assign them different protective actions.

Different threshold values may mean that with respect to the same parameter, e. g. the torque or the bending moment, several different values are defined for different levels of protective action escalation, and/or different parameters can be evaluated, for instance an early first warning, calculated from the bending moment, on impending wear, and additionally an urgent warning which immediately switches off the extruder when the threshold value is reached, with reference to the current torsional moment of the screw.

In the prototype tests performed by the inventors, wire strain gauges for the sensor have proved to be very successful.

Wire strain gauges are commercially available in various ways. They are always available and can be bought at low cost. They also work very precisely. From an alteration in resistance, an alteration in length of the path located beneath the adhesive wire strain gauge, e. g. in this case of the screw and/or the coupling, can be deduced with precision.

In addition, wire strain gauges occupy only very little space so that they can also be easily attached inside the flange leading to the cylinder, for instance at a coupling which is arranged there.

Due to the low costs of a wire strain gauge, wire strain gauges can also be easily arranged redundantly, for instance, two or more wire strain gauges for the same value.

The sensor can also be provided with an optical system, in particular a laser and light-beam recording.

By means of a laser, a particularly precise and contactless measurement, for instance of windings of the screw, can be performed.

When a magnetic or inductive sensor is provided, additional information on the screw can easily be obtained. In particular, balance errors of the screw during rotation can easily be recognized.

It is suggested that the controller have a data connection to a database which can be updated externally.

The database can either be locally assigned at the extruder exclusively to the controller, or it can be a database used by several extruders which are all local, for example, in a factory; or it can be a company-wide database or a database with a different legal structure which can also be accessed in the data network, for instance, via the Internet.

Thus, it is conceivable that a manufacturer of extruders regularly stores the currently available extruders and screws, or even the formerly used extruders and screws, which are no longer available, in the database, where the machines can retrieve the data specifically suited for them. This can be done in a retrieval process, or a push signal can be given to the machine by the database.

If more precise or new information about wear is obtained over the operating time of specific extruder models, this information can be continuously updated by the user, in particular, by the extruder manufacturer.

The prognosis on wear should also be able to access at least one parameter of the material to be processed.

A preferred embodiment of the disclosure envisages for the controller to have an input interface for recording geometric measurement and/or optical values concerning the screw and/or the cylinder which are input manually.

For instance, it must be kept in mind that even with progressive electronic monitoring, the extruders must be physically maintained on a regular basis. For this purpose, the screw is removed. The screw and the cylinder can, for example, be cleaned or measured.

By means of the actual measured values of cylinder and/or screw, the forecast values for wear can be adjusted. This leads, for instance, to a qualitatively improved prognosis of the production conditions prevalent at a machine, such as ambient temperature, air quality, quality of the carbon granulates or of the loading materials, operating precision etc.

For excluding operating errors as far as possible, it is an advantage if the extruder is adapted to record measured values. For instance, a camera or measuring unit can be provided on the extruder by means of which the cylinder and the screw are automatically recorded optically or measured otherwise or can be photographed by the maintenance personnel. From the recorded data, the controller can directly determine the actual values of wear, such as e. g. the abrasion in the diameter of the screw. Even with untrained personnel, the forecast values can thus be adapted with a view to local wear in an objectively ideal manner.

The controller preferably has an adjusting algorithm for calculating the threshold value or the different threshold values or parameters or for adapting the (various) threshold value(s) using the manually input values or the values which have been recorded optically or otherwise automatically.

It is understood that the advantages of the above-mentioned extruder also extend directly to a plastic molding plant, in particular a plant for manufacturing a film, in particular a blown-film plant or a flat-film line, or for producing a fleece or a monofilament, when an extruder as described above is used, as well as a nozzle unit and preferably a winding unit; as well as for use in a direct extrusion or compounding plant.

Such a plant can also have several extruders. It is not necessary for all extruders to be embodied as described above. The more extruders are embodied as described above, however, the better it will be for the plant.

In a third aspect of the present disclosure, the disclosure provides a method for operating a plant as described above, having an extruder as described above, is provided, the method comprising the following steps: (a) measuring a torque and/or a bending moment in the extruder by means of a sensor; (b) transferring data on the recorded moment load to the controller; (c) evaluating the data by means of the controller, evaluating comprising a frequency calculation, in particular a bending moment frequency calculation and/or a bending moment calculation.

Concerning the first and the second aspect of the present disclosure, the advantages that can be achieved by such a method have already been explained above.

In the calculation, data are preferably grouped in classes.

This means that the frequency in occurrence of a specific value is not only determined by means of the exact value, but that several similar values within predefined class limits are to be assigned to one class, just as if the same value had been measured.

For instance, an amplitude of approximately 50 Nm can be measured in the bending moment. An exemplary classification could then be performed by adding the amplitudes of specific values plus/minus 5 Nm to the basic value so that, for instance, all measured values from >10.0 to 20.0 Nm are added to the class around 15 Nm.

If the classes are selected intelligently, processing of the measured values will be more comprehensible to the operating personnel.

It has already been mentioned that the amplitudes, in particular the amplitudes of the bending moment, can be monitored. In prototype tests, a class of about 5 Hz to 6 Hz has been proven to be especially important.

It seems meaningful to group the data of a frequency bandwidth of at least 0.2 Hz, in particular at least 0.5 Hz or at least 1 Hz, in one class when a frequency calculation is performed; in terms of bending moment calculation, it seems useful to group the data of a bending moment bandwidth of at least 5 Nm, in particular at least 10 Nm, in one class.

The range of values from 0 Hz to 1 Hz corresponds to the statistic offset.

The same can be performed in an analogous manner for the offset of the bending moment.

To be able to record and further predict wear of the extruder, it is proposed that especially the offset of the bending moment be monitored for change, in particular for reduction.

Alternatively or in addition, the amplitude of the bending moment can be monitored for change, in particular for reduction.

One useful measure for increasing the lifetime of the extruder can be to set the coupling, in particular a safety friction clutch, such that it is triggered more easily with increasing wear.

In the following, the disclosure will be explained in more detail by means of trial protocols.

### BRIEF DESCRIPTION OF THE DRAWINGS

FIG. 1 schematically shows a system description of a double-screw extruder 1 having a double-lead screw 2, connected to a drive train 6 with a motor via measurement couplings 3, a gear 4 and a safety friction clutch 5.

FIG. 2 allows a better view of the measurement couplings, which are arranged between the gear 4 and the screw shafts 7, 8. Wire strain gauges (identified by way of example) are attached to the measurement couplings 3.

FIG. 3 worn (right) and new (left) kneading block

FIG. 4 worn (right) and new (left) conveying element

FIG. 5 amplitude of left torque with prototype

FIG. 6 amplitude of right torque with prototype

FIG. 7 offset of left torque with prototype

FIG. 8 offset of right torque with prototype

FIG. 9 amplitude of left bending moment with prototype

FIG. 10 amplitude of right bending moment with prototype

FIG. 11 offset of left bending moment with prototype

FIG. 12 offset of right bending moment with prototype

FIG. 13 average torque, variation of specific throughput of prototype

FIG. 14 amplitude of torque, variation of specific throughput of prototype

FIG. 15 amplitude of torque, variation in pressure at screw tip of prototype

FIG. 16 amplitude of torque, variation in absolute throughput of prototype

FIG. 17 average of bending moment, variation in absolute throughput of prototype

FIG. 18 frequency spectrum of right bending moment

FIG. 19 frequency spectrum of left bending moment

FIG. 20 torques of the test points

FIG. 21 variation of specific throughputs

FIG. 22 variation of cylinder temperature

FIG. 23 variation of absolute throughputs

FIG. 24 torques of the test points

FIG. 25 variation of specific throughputs

FIG. 26 amplitudes of torques of screw plug-in mounts 1, 2 and 3 at 400 kg/h

FIG. 27 averages of torques of screw plug-in mounts 1, 2 and 3 at 400 kg/h

FIG. 28 amplitudes of bending moments of screw plug-in mounts 1, 2 and 3 at 400 kg/h

FIG. 29 averages of bending moments of screw plug-in mounts 1, 2 and 3 at 400 kg/h

FIG. 30 amplitude torque, variation of absolute throughput

FIG. 31 average torque, variation of absolute throughput

FIG. 32 amplitude bending moment, variation of absolute throughput

FIG. 33 average bending moment, variation of absolute throughput

FIG. 34 torque left screw (frequency range)

FIG. 35 left bending moment (frequency range)

FIG. 36 torques and bending moments left (over a time range)

FIG. 37 amplitudes of the bending moments over the test points, right bending moment

FIG. 38 corresponding left bending moment

FIG. 39 offset of bending moments over the test points, right bending moment

FIG. 40 corresponding left bending moment

FIG. 41 bending moments with variation of specific throughput, amplitude of bending moment

FIG. 42 corresponding average of bending moment

FIG. 43 torques with variation of pressure at the screw tip, amplitude bending moment

FIG. 44 corresponding average of bending moment

FIG. 45 bending moments with variation of absolute throughput, amplitude of bending moment; and

FIG. 46 corresponding average of bending moment

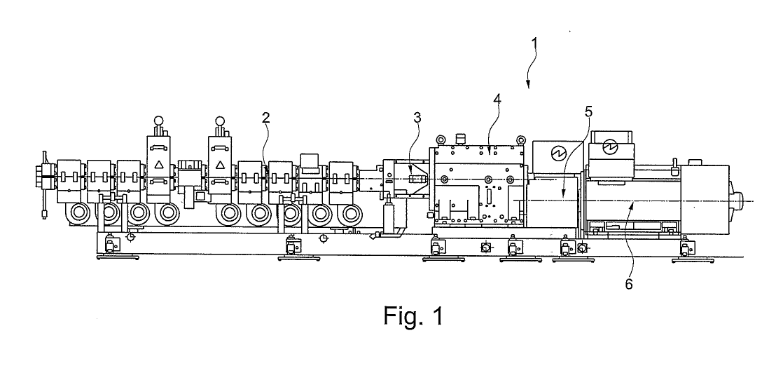

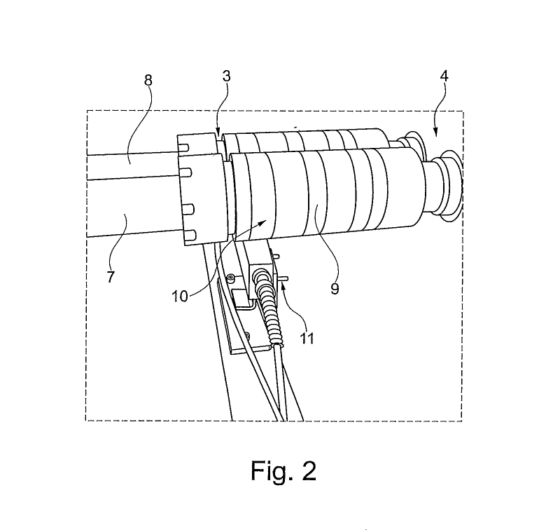

### DETAILED DESCRIPTION OF THE DRAWINGS

At the same time, a rotor antenna 10, arranged directly above a stator antenna 11, rotates together with the screw shafts 7, 8.

Torque measurement and bending moment measurement take place by means of wire strain gauges 9 attached to the measurement couplings 3. In case of torsion or bending of the screw shafts 7, 8, the ohmic resistance of the wire strain gauges 9 changes. By means of a full bridge, a measurement voltage is created by the change in resistance, which voltage is proportional to the torque or the bending moment, respectively. The measurement voltage is then amplified by a signal amplifier and converted into a bit sequence by an analog/digital converter. Via the rotor antenna 10, the digitized sensor values from the measurement couplings 3 are then wirelessly transferred to the stator antennae 11.

From the stator antennae 11, the data are then transmitted via cable to an evaluation unit (not shown here). Via a digital/analog converter, an analog output signal is again output which can either be transferred to a PC via an analog/digital converter, or the measurement system used here can read in and process the data directly.

The measurement system used was a system by Manner Sensortelemetrie GmbH, 78549 Spaichingen, Germany.

In the following, excerpts from the trials performed by the inventors will be presented which better explain the disclosure to the person skilled in the art:

Protocol Excerpts From the Trials

The sensor technology used makes it possible to gain an insight into the current load states of the screws. For examination of wear, the task is to find out whether the sensor technology used is also suitable to detect screw wear.

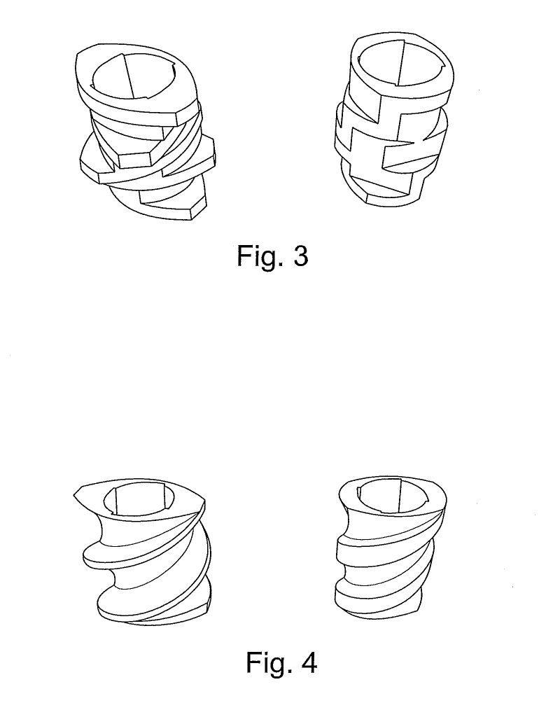

For this purpose, the torque and bending moment signals of a new-value screw are to be recorded so that they can subsequently be used as reference signals. In the subsequent measurements, a wear on individual segments, which is at first relatively strong, is to be simulated. For this purpose, individual segments which, as experience has shown, are regularly subject to greater wear, are mechanically reworked. The employed kneading blocks and screw segments are reduced by approximately 10 mm in diameter so as to represent a strong state of wear (see FIG. 3 and FIG. 4).

Subsequently, the same test points are to be measured as in the reference measurements so as to ensure comparability of the results. A comparison of the measured values is then supposed to allow a conclusion on whether it is possible to signal a screw wear by alterations of the measured values.

Test Procedure

Both for the reference measurements and for the subsequent tests, PP-MF1-3 is used as the raw material.

A test procedure is set up in which the absolute throughput is varied as well as the specific throughput and the pressure on the screw tip (see Table 1). Thus, alterations of the measured values due to variation of the machine parameters can be directly compared to any alterations caused by wear.

To facilitate any subsequent statistic tests, a test point with an absolute throughput of 400 kg/h, a specific throughput of 2.7 kg*min/h and a pressure of 60 bar is defined as the central point (line no. 1 of the table). Starting from this test point, the absolute throughput, the specific throughput and the pressure at the screw tip will all be varied (specific throughput in lines 3 and 4; pressure in lines 5 and 6 and absolute throughput in lines 7 and 8). The test points for the examinations on wear are listed in Table 1. Also, the second test point is measured with the same parameters as the first one for an examination of the variations in case of repeated measurement at one test point.

TABLE 1
test plan for examinations on wear

| | AD | SD | P | T | D |
|---|---|---|---|---|---|
| no. | [kg/h] | [kg*min/h] | [bar] | [° C.] | [rpm] |
| 1 | 400 | 2.7 | 60 | 240 | 148.1 |
| 2 | 400 | 2.7 | 60 | 240 | 148.1 |
| 3 | 400 | 2.3 | 60 | 240 | 173.9 |
| 4 | 400 | 3.1 | 60 | 240 | 129.0 |
| 5 | 400 | 2.7 | 40 | 240 | 148.1 |
| 6 | 400 | 2.7 | 80 | 240 | 148.1 |
| 7 | 300 | 2.7 | 60 | 240 | 111.1 |
| 8 | 500 | 2.7 | 60 | 240 | 185.2 |

AD: absolute throughput
SD: specific throughput
P: pressure
T: temperature
D: rotational speed

First, each test point is stabilized over a certain period of time. Then, the torques and bending moments are recorded by means of a Ganter measurement system over a period of five minutes. The measured values are low-pass-filtered by means of the measurement system with a cut-off frequency of 500 Hz and scanned with a scanning frequency of 5000 Hz. Thus, the scanning rate is at least 10 times higher than the maximum frequency occurring in the signal, so as to prevent aliasing as far as possible.

Aliasing errors are errors caused by the occurrence of frequencies within the signal which are above the Nyquist frequency (half of the scanning frequency). They cause the original signal to be distorted after scanning. The higher the selected scanning rate, the higher the precision of the reconstructed digitized signal. However, this is also linked to greater calculation efforts and a larger amount of data.

The measuring results from the test series are first transferred into the frequency range by means of a fast Fourier transformation (FFT; a fast Fourier transformation is a variant of the discrete Fourier transformation which is optimized in terms of computing time). In the frequency spectra, the frequencies occurring within the signal, the corresponding amplitudes and the offset of the torque and bending moment oscillations are then evaluated. For performing the fast Fourier transformation, a Scilab program code is written. The amplitudes of the FFT are standardized so that the amplitudes of the individual oscillation components can be directly read from the frequency spectrum. Also, the measured values are multiplied by the Hanning window function. The offset of the oscillations and the amplitudes of the basic frequency can be directly read out from the variable browser of the simulation program and do not have to be analyzed with great effort within the time range. Also, in this way it becomes possible to read all other frequency components below the cut-off frequency of 500 Hz from the frequency spectrum with the corresponding amplitudes.

The simulation program Scilab is a universal Open-Source software package with functions very similar to those of Matlab. The programming language also is very similar to that of Matlab.

Test Results

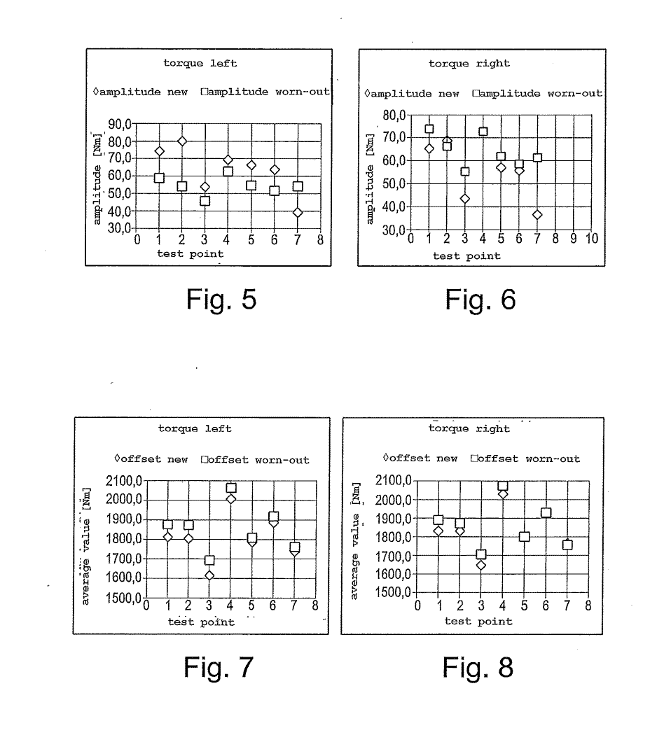

First, the amplitudes and average values of the torques of the eight test points, on the left and on the right screw shaft, are examined. As can be seen in FIG. 6, the right screw shaft of the worn-out screw has a larger amplitude than the new-value screw shaft. For the left screw shaft (see FIG. 5), the opposite is the case; the new-value screw shaft has a larger amplitude than the worn one. This applies to nearly all test points; therefore, the test points numbered 2 in FIGS. 6 and 7 in FIG. 5 are first regarded as runaway values. Also, it becomes clear that in the new-value screw, the left screw shaft has a larger amplitude than the right screw shaft. In the worn-out screw, the opposite is the case.

As far as the average torque values are concerned, the worn-out screw shaft is subjected to a higher load than the new-value screw, both on the right and on the left side (see FIGS. 7 and 8). The average values of the right new-value screw shaft are slightly higher than those of the left one. This also applies to the worn-out screw; there, however, the difference between the left and the right screw shaft is less pronounced.

All diagrams show clearly that the change in average and amplitude between the worn-out screw and the new-value screw is relatively small. The variations in amplitude and average value between the individual test points are much higher so that it is always necessary to refer to the current operating state in order to be able to give a statement on wear. Also, it is at first still unknown how large the variations are if a test point is measured repeatedly. If the operating parameters, such as material, temperature profile, throughput etc., are changed frequently, the possibility of reliably determining screw wear from amplitudes or changes in average of torque values, is deemed to be relatively small.

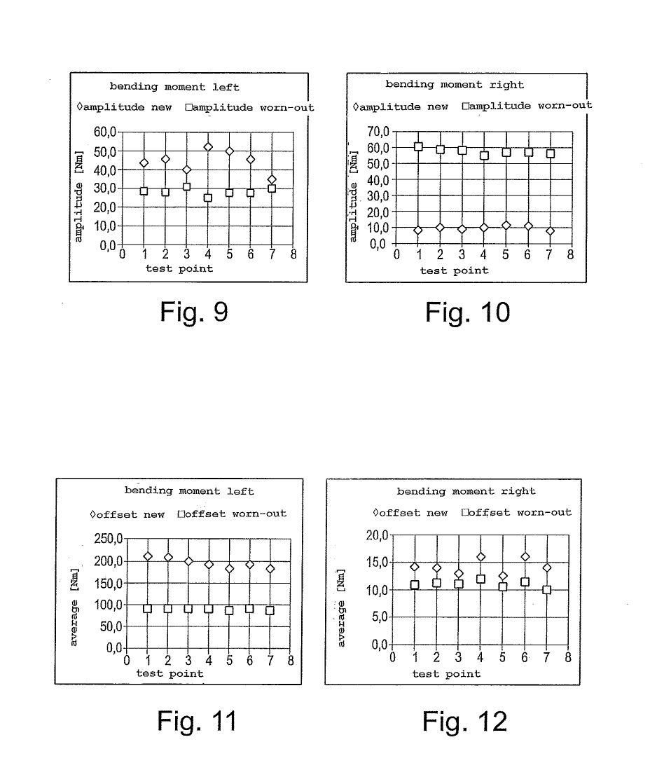

Subsequently, the amplitudes and average values of the bending moment signals are evaluated. As can be clearly seen in FIGS. 9 and 10, the amplitude of the worn-out screw shaft strongly rises on the right side whereas it slightly drops on the left side.

Regarding the average values of the bending moments, it becomes obvious that the offset of the right screw shaft hardly changes whereas the average value of the worn-out left screw shaft is only approximately 50% of that of the new-value screw (see FIGS. 11 and 12). This applies to all test points.

As with the torques, it is also with the bending moments that the amplitude increases with wear in case of the right shaft and is reduced in case of the left shaft.

On first sight, the amplitude of the bending moment of the right screw shaft seems to be very well-suited for wear measurement. The change in amplitude caused by screw wear is relatively pronounced in comparison to the change between the individual test points (see FIG. 10). At first, however, this applies only to the present screw plug-in mount and to the predefined strong wear of kneading block and conveying segment. Therefore, it cannot be excluded that with a different screw plug-in mount, a different position of the worn-out segments or use of a different raw material, the amplitude of the bending moment again proves not to be useful. On the other hand, the tests with different plug-in mounts show results similar to those of the measurements with the new-value screw for all three plug-in mounts, although with PET a different raw material was processed. Nevertheless, additional tests are regarded as recommendable in order to verify the strong change in amplitude also for other conditions and to exclude any measurement errors.

With the left screw shaft, the amplitude is less significant. However, the average of the bending moment shows a clear reduction by approximately 50% in the worn-out screw as compared to the new-value screw (see FIG. 11). The value of the latter, like the amplitude of the right screw shaft, is only subject to slight variations over the different test points. On the other hand, the change in average value of the left screw should be verified by additional tests as well.

In addition, as in the preceding trials, any possible dependencies of the measured values on operating parameters, such as temperature profile, absolute throughput, specific throughput and pressure, should be examined.

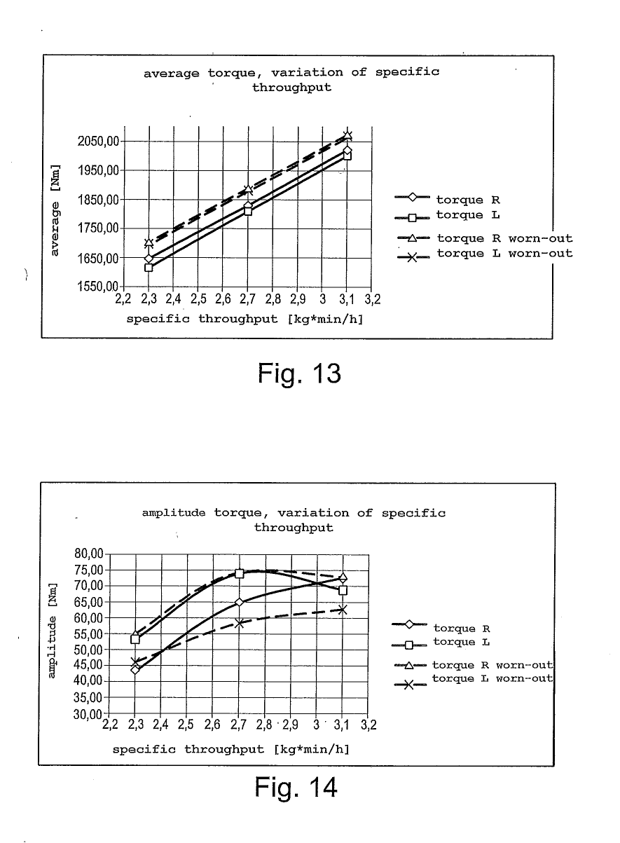

The specific throughput is varied with a constant absolute throughput of 400 kg/h and a constant pressure of 60 bar at the screw tip. If the specific throughput is increased, as can be seen in FIG. 13, a clear and nearly linear rise in average values of the torques results. For the amplitudes, no clear dependency can be seen. Whereas the amplitudes of the right new-value screw and of the left worn-out screw continuously rise with increase of the specific throughput, those of the right worn-out screw and of the left new-value screw drop (see FIG. 14). Thus, it is not possible to make a clear statement about a change in amplitude. For the amplitudes of the bending moments, as for those of the torques, it is not possible to make an unambiguous statement. The average values of the bending moments remain relatively constant. The results can be seen in the test protocol on wear measurements, which is included in the annex.

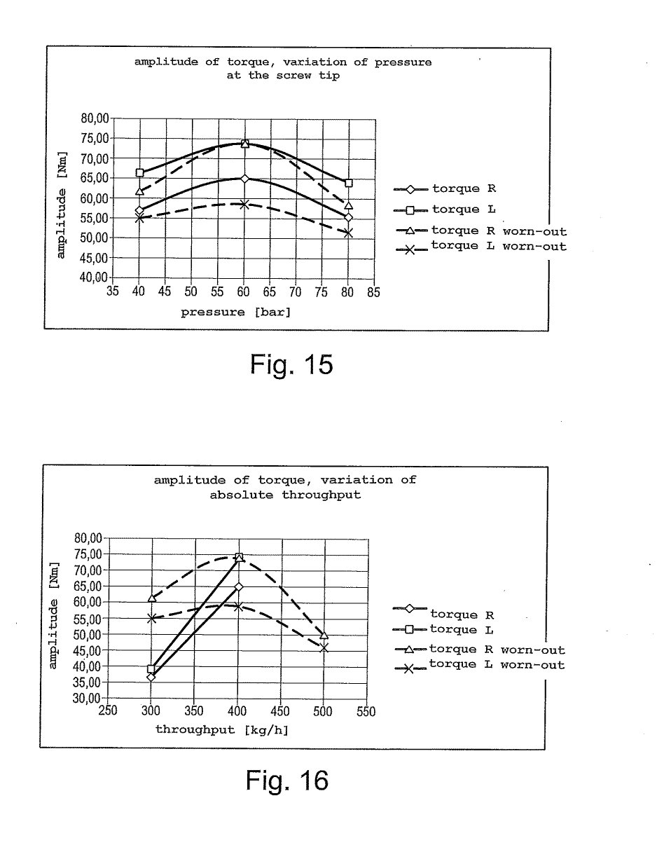

Furthermore, in the trials, the pressure at the screw tip was varied with a constant specific throughput of 2.7 kg*min/h and a constant absolute throughput of 400 kg/h. The amplitudes of the torques first show a rise with an increase from 40 to 60 bar and then, with a further increase in pressure from 60 to 80 bar, they drop to the lowest point (see FIG. 15). The average values of the torques, on the other hand, continuously rise with increasing pressure.

The amplitudes of the bending moments exhibit a different behavior depending on whether one looks at the worn-out or at the new-value screw. For the new-value screws, the amplitude drops in case of a pressure increase from 40 to 60 bar and then slightly rises again with an increase from 60 bar to 80 bar. For the worn-out screw, on the other hand, the amplitude slightly rises with an increase to 60 bar and then slightly drops again in case of a further increase to 80 bar. The average values of the bending moments slightly rise with the increase in pressure. The average value of the left new-value screw is a runaway value since it slightly drops with an increase from 60 bar to 80 bar.

In addition to the pressure and the specific throughput, the absolute throughput was also varied with a constant pressure of 60 bar and a constant specific throughput of 2.7 kg*min/h.

With the worn-out screw, all three test points could be measured. As with the variation in pressure, the amplitudes of the torques also slightly rise, from 300 kg/h to 400 kg/h, with an increase in absolute throughput and then drop quite strongly with a further increase to 500 kg/h (see FIG. 16). The behavior of the amplitudes of the bending moment signals is roughly comparable.

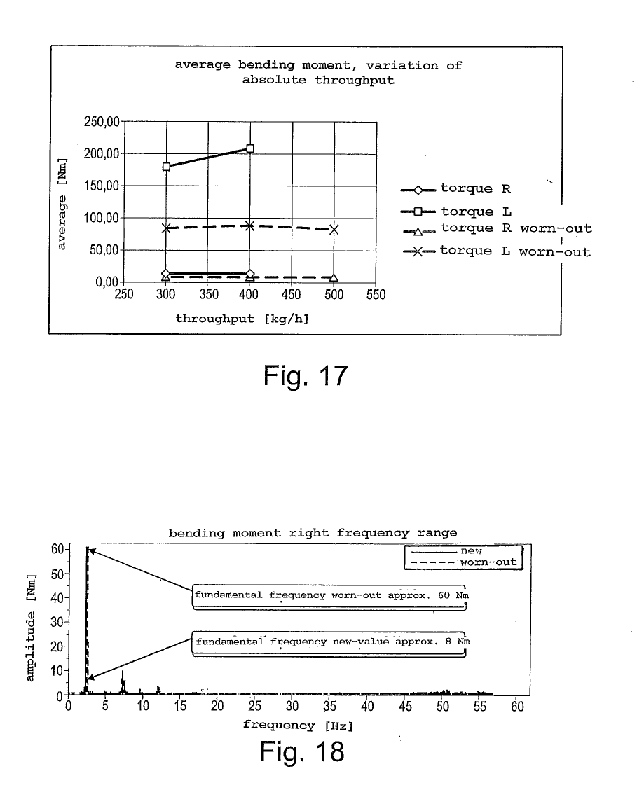

The average values of the torques continuously rise with an increase in absolute throughput. The average values of the bending moments remain relatively constant, as in all other diagrams. The only runaway value is the average value of the left new-value screw (see FIG. 17).

Finally, the different frequency components are examined which occur in the torque and bending moment signals at the various test points. The different amplitudes of the fundamental frequency of the reference signal and of the signal of the worn-out screw segments can be clearly distinguished (see FIG. 18).

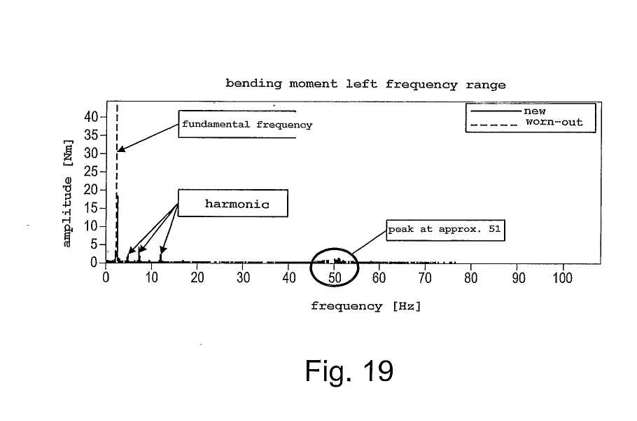

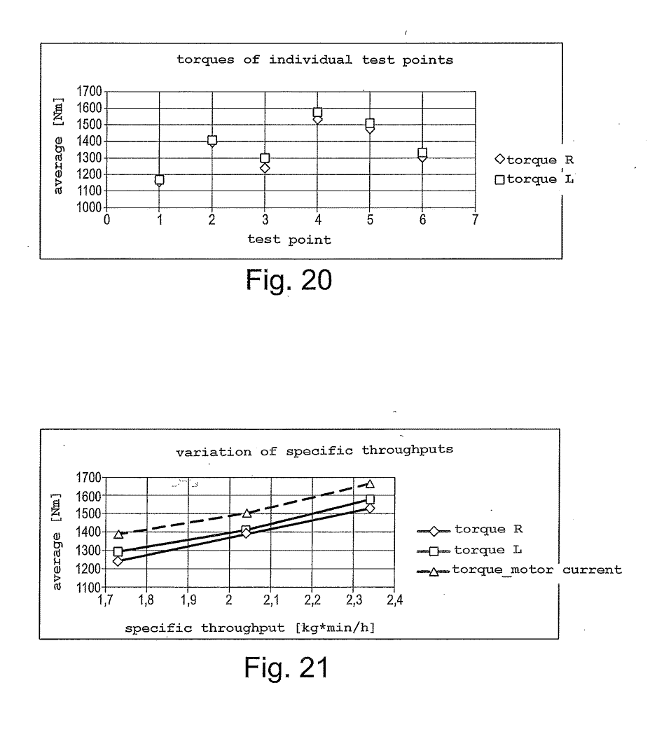

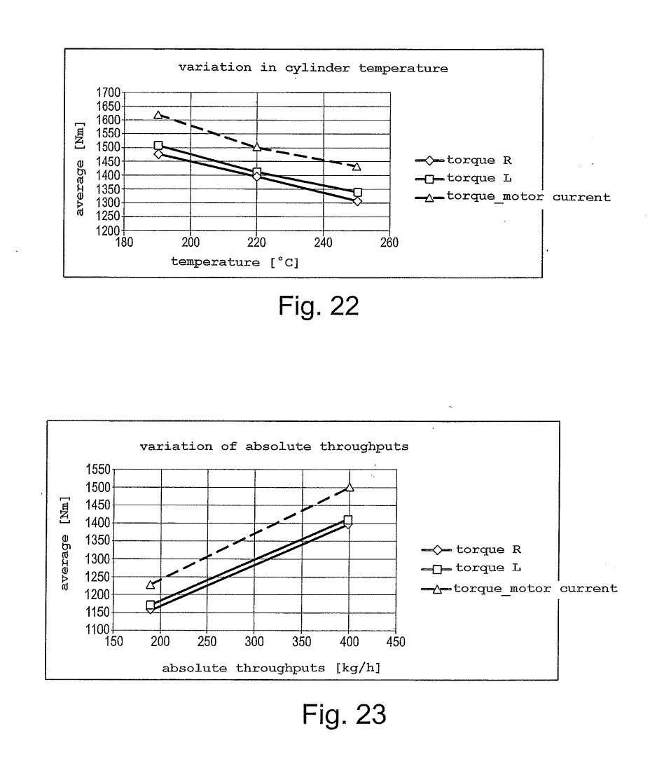

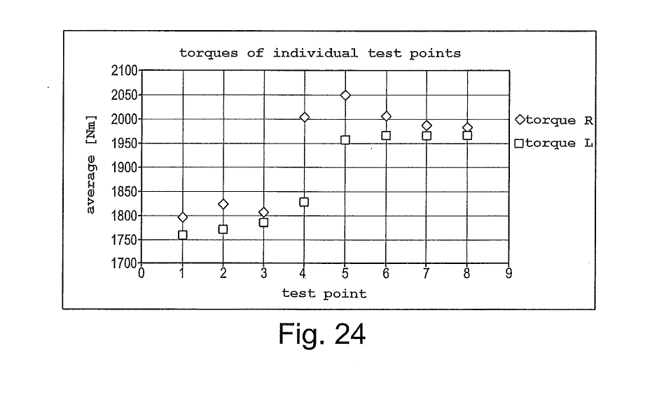

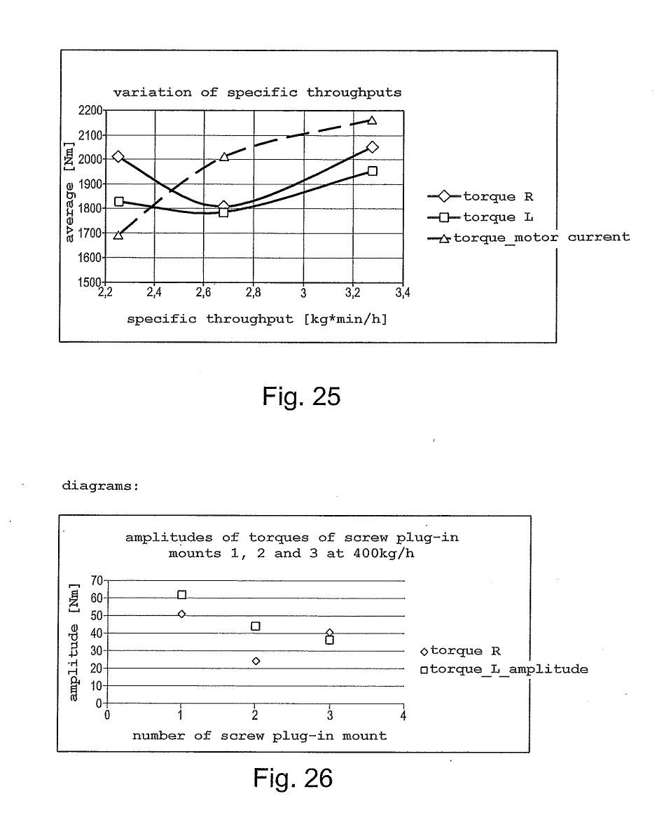

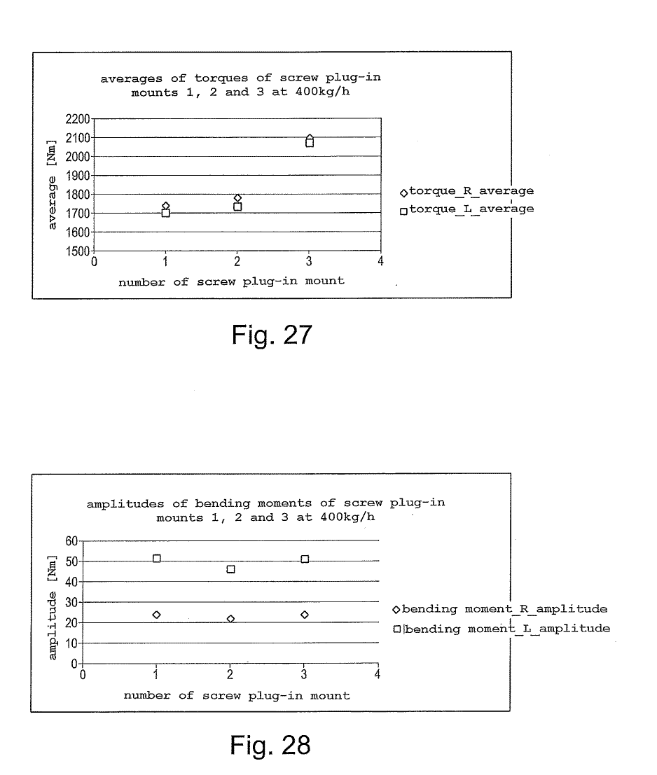

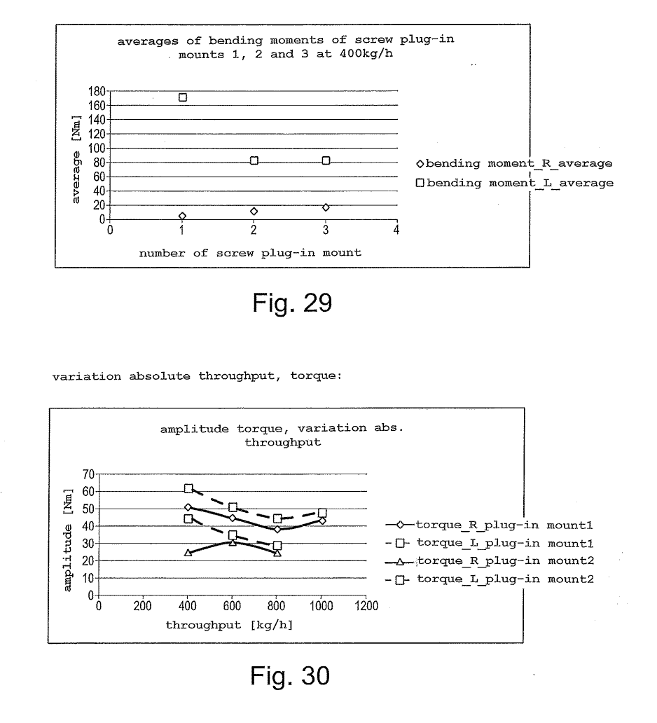

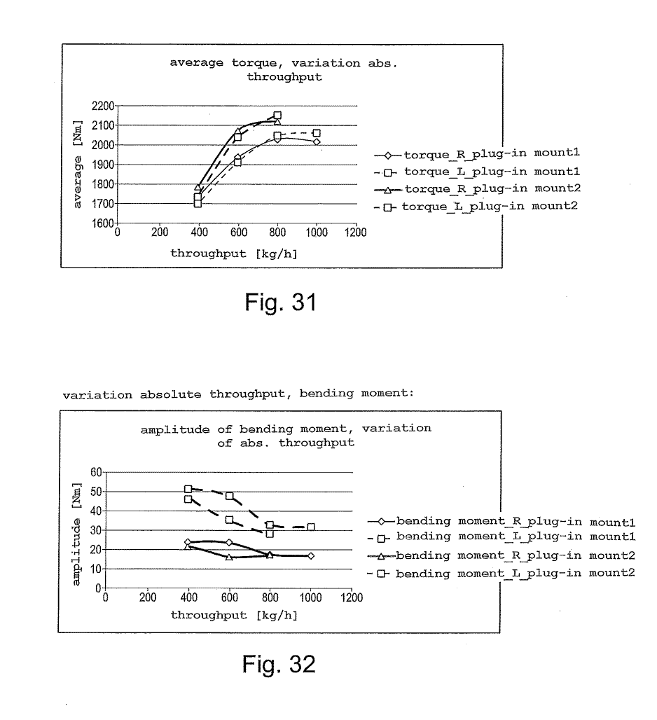

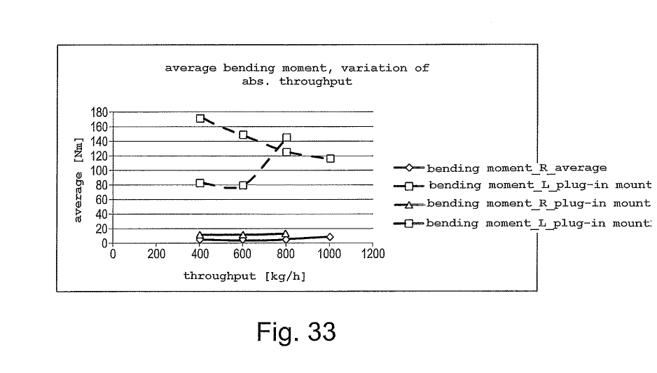

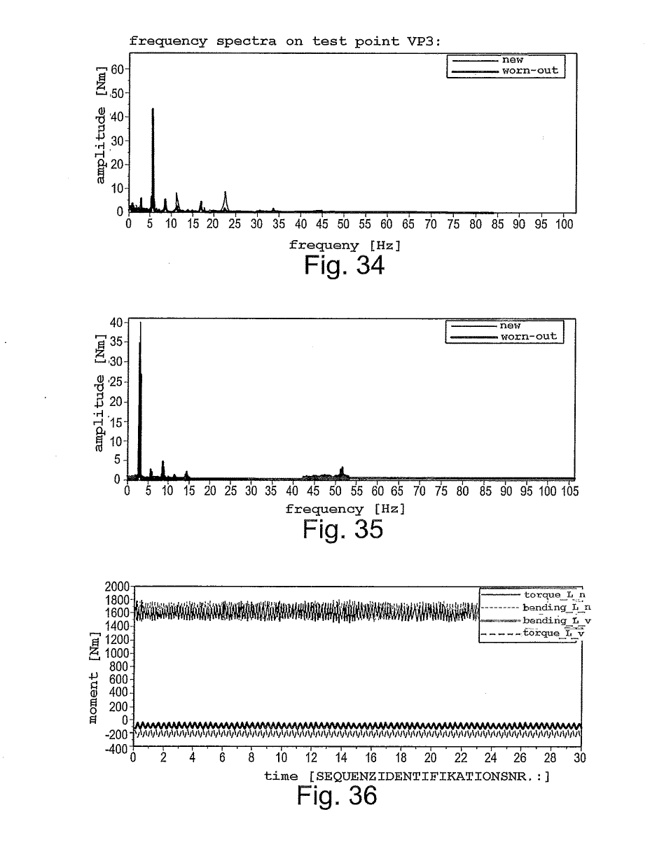

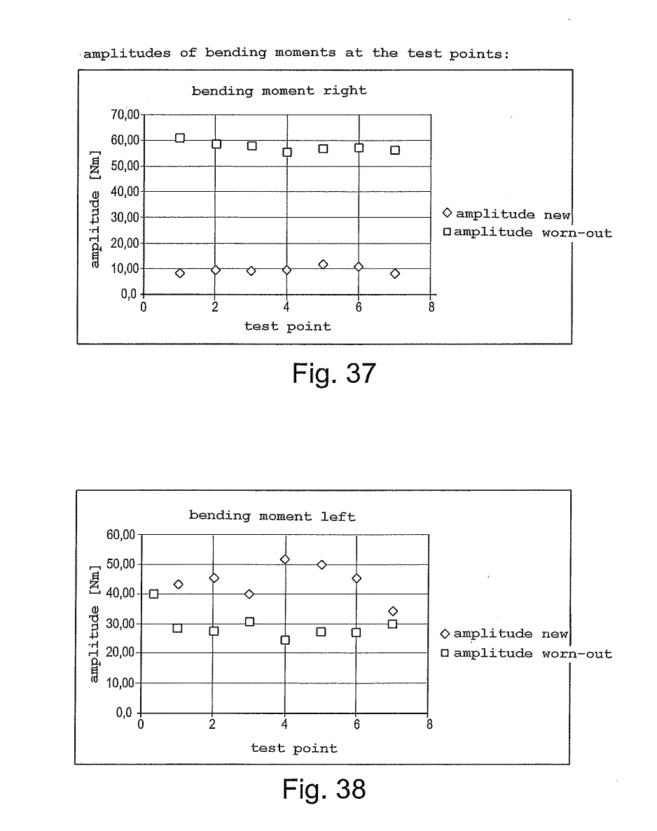

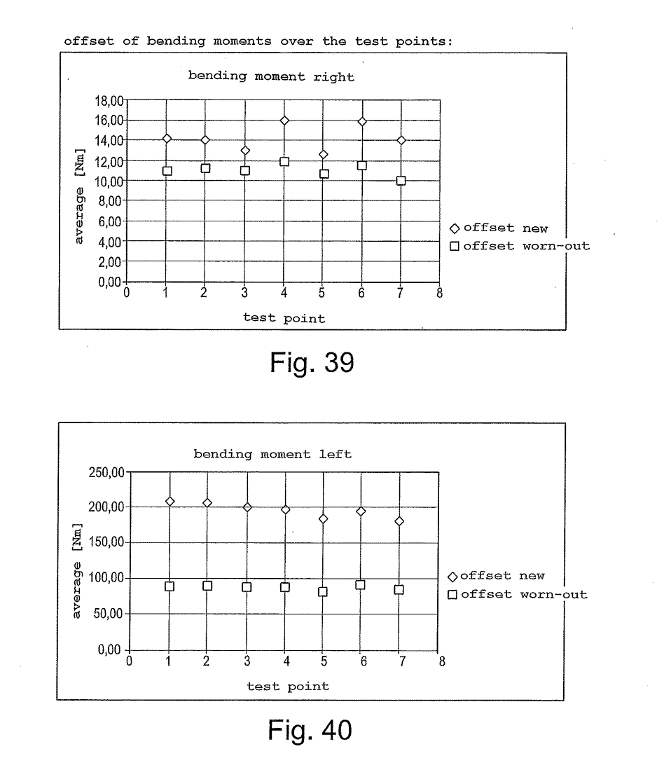

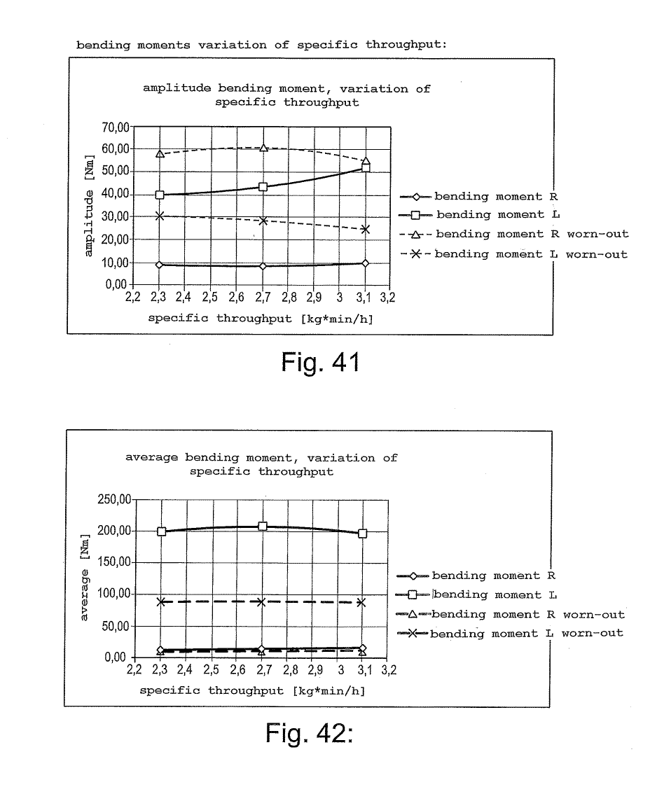

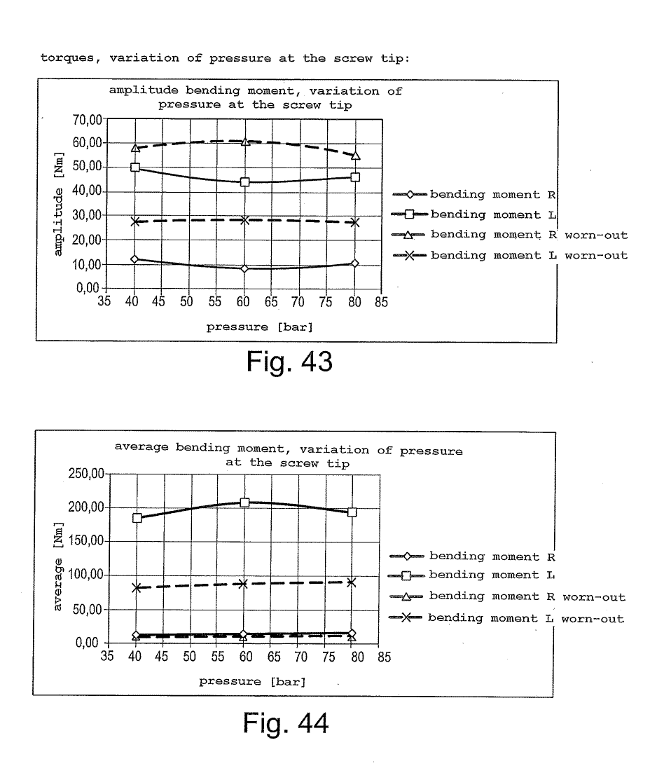

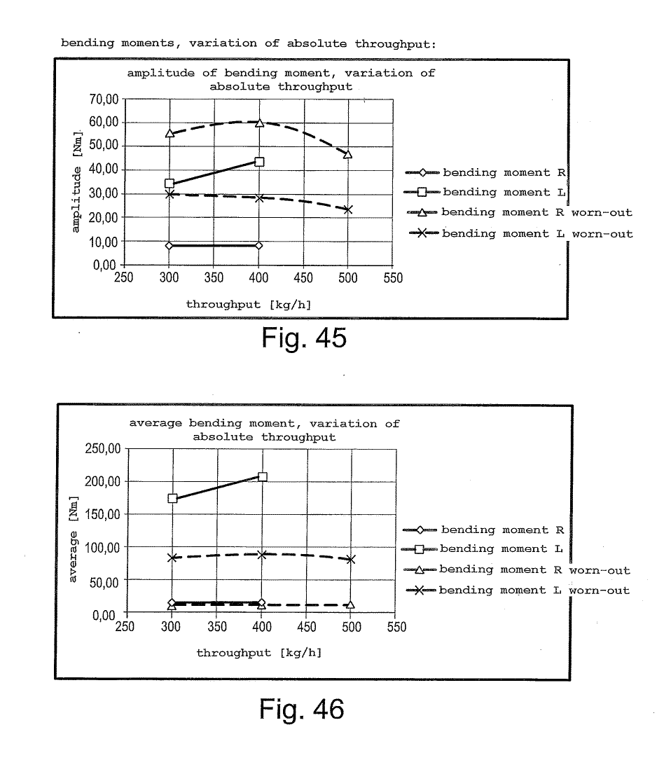

The other frequency components are largely harmonic oscillation components of the fundamental frequency. In advance, it had been hoped that, as in a bearing damage, an oscillation would occur in the worn-out screw which oscillation would not be a harmonic of the fundamental frequency. However, this was not confirmed by the measured values. Only the bending moments show a low amplitude at a frequency of approximately 51 Hz, which, however, can partly also be observed both in the reference signal and in the signal of the worn-out segments (see FIG. 19).

It is also probable that a power-line frequency of 50 Hz may influence the bending moment signals.

Summary and Outlook

The tests of the examinations on wear show that an online wear measurement by means of the employed sensor technology might well be possible.

Whereas the measurement data for the torques are of less significance concerning screw wear, clear changes in the measured values of the bending moment signals due to the use of worn screw segments can be seen.

Thus, for the right screw shaft, use of the worn-out segments leads to an increase in amplitude of approximately 400% to 600% as compared to the reference signal, with a relatively low dependency on throughput, pressure etc. However, this change in amplitude cannot be seen with the left screw shaft; here, the amplitude is even slightly reduced by the use of the worn segments. What is relatively clear for the left screw, however, is a change in offset. Whereas the offset of the right screw remains nearly unchanged, the offset of the left screw is reduced by approximately 50%. Similar to the amplitude of the right screw shaft, the offset of the left shaft shows only a slight dependency on the set machine parameters.

As in the preceding trials for the prototype, the bending moment of the right screw exhibits a changing load and that of the left one exhibits an increasing load. In the new-value screw segments, both the average value and the amplitude of the left screw are significantly higher than those of the right screw.

With use of the worn-out segments, the load on the right screw shaft then rises whereas the load on the left screw clearly decreases. However, a changing load on the right screw and an increasing load on the left screw shaft can still be observed.

Other than the bending moments, the torques exhibit only minor changes in the measurement data with the use of worn-out segments. Also, a strong dependency on throughput, pressure etc. can be seen which substantially limits the use of the torques for online wear measurement.

The behavior of the bending moments, above all, therefore promises success as the basis for determining wear.

Furthermore, the influence of different raw materials, different screw plug-in mounts and different positions of the worn-out segments on the measured values should possibly be examined as well. However, the tests with different PET screw plug-in mounts on the prototype exhibit a similar behavior of the bending moments. Thus, the screw plug-in mount does not seem to have a particularly strong influence on the bending moments.

It must also be kept in mind that the simulated wear must at first be regarded as being idealized. This wear is symmetrical over the circumference, constant over the length of the screw segments and equally strong on both screw shafts, which in no way represents realistic conditions. Therefore, it cannot be excluded that long-time trials may be necessary since the real wear behavior will differ from the one in the tests.

If, however, future trials should indicate similarly strong changes in the bending moments if worn-out segments are used, it can be assumed that a reliable early recognition of worn-out screw segments by means of online wear measurement is basically possible. It would, for instance, be conceivable to periodically perform a measurement in which the amplitudes and median values of the bending moments are evaluated. In case defined threshold values are exceeded, for instance, a warning signal could indicate a worn-out screw shaft. The main challenge for this situation would be to make a meaningful distinction between a worn-out screw and a screw which is not worn-out.

Additional Tables:

Measurements RZE 70 PP-Granula

TABLE 2

| author | date | material | — | plant |
|---|---|---|---|---|
| P. Michels | Apr. 10, 2014 | polypropylene (PP) | granulate | RZE 70 |

Experimental Design:

TABLE 3

| | | temperature | | specific | rotational |
|---|---|---|---|---|---|
| | | setting | throughput | throughput | speed |
| test no. | screw | [° C.] | [kg/h] | [kg*min/h] | [rpm] |
| 1 | left | 220 | 189 | 1.97 | 96 |
| | right | | | | |
| 2 | left | 220 | 399 | 2.04 | 196 |
| | right | | | | |
| 3 | left | 220 | 409 | 1.73 | 237 |
| | right | | | | |
| 4 | left | 220 | 391 | 2.34 | 167 |
| | right | | | | |
| 5 | left | 190 | 362 | 1.96 | 185 |
| | right | | | | |
| 6 | left | 250 | 387 | 2.02 | 192 |
| | right | | | | |

Test Results

TABLE 4

| | | | | | | | | period |
|---|---|---|---|---|---|---|---|---|
| | | | | torque | | | period | duration |
| | | torque | motor | motor | devia- | torque | duration | screw |
| | | average | current | current | tion | ampli- | torque | rotation |
| no. | | [Nm] | [%] | [%] | [%] | tude | [s] | [s] |
| 1 | L | 1170 | 55% | 1225.5 | 4.5 | 67.5 | 0.32 | 0.625 |
| | R | 1155 | | | 5.8 | 67.5 | 0.32 | |
| 2 | L | 1408 | 66% | 1503 | 6.3 | 76.5 | 0.16 | 0.31 |
| | R | 1391 | | | 7.5 | 77.5 | 0.15 | |
| 3 | L | 1296 | 60% | 1387 | 6.6 | 81.5 | 0.127 | 0.25 |
| | R | 1243 | | | 10.4 | 79.5 | 0.125 | |
| 4 | L | 1578 | 72% | 1665 | 5.2 | 86 | 0.175 | 0.36 |
| | R | 1531 | | | 8 | 81.5 | 0.178 | |
| 5 | L | 1507 | 70% | 1618 | 6.9 | 88 | 0.171 | 0.32 |
| | R | 1478 | | | 8.4 | 84.5 | 0.168 | |
| 6 | L | 1338 | 61% | 1443 | 6.6 | 77.5 | 0.16 | 0.31 |
| | R | 1304 | | | 9 | 75 | 0.15 | |

Variation of Specific Throughputs:

TABLE 5

| | | spec. | | | | | | | |
|---|---|---|---|---|---|---|---|---|---|
| | | through- | | | | torque | | | |
| | | put | torque | | | motor | | change | change |
| | | [kg* | average | change | change | current | amplitude | amplitude | amplitude |
| no. | | min/h] | [Nm] | [Nm] | [%] | [Nm] | [Nm] | [Nm] | [%] |
| 2 | L | 2.04 | 1408 | — | — | 1503 | 76.5 | — | — |
| | R | | 1391 | — | — | | 77.5 | — | — |
| 3 | L | 1.73 | 1296 | −112.00 | −7.95 | 1387 | 81.5 | 5.00 | 6.54 |
| | R | | 1243 | −148.00 | −10.64 | | 79.5 | 2.00 | 2.58 |
| 4 | L | 2.34 | 1578 | 170.00 | 12.07 | 1665 | 86 | 9.50 | 12.42 |
| | R | | 1531 | 140.00 | 10.06 | | 81.5 | 4.00 | 5.16 |

Variation in Temperature:

TABLE 6

| | | | | | | torque | | | |
|---|---|---|---|---|---|---|---|---|---|
| | | | torque | | | motor | | | change |
| | | temp. | average | change | change | current | amplitude | change | amplitude |
| no. | | [° C.] | [Nm] | [Nm] | [%] | [Nm] | [Nm] | amplitude | [%] |
| 2 | L | 220 | 1408 | — | — | 1503 | 76.5 | — | — |
| | R | | 1391 | — | — | | 77.5 | — | — |
| 5 | L | 190 | 1507 | 99.00 | 7.03 | 1618 | 88 | 11.50 | 15.03 |
| | R | | 1478 | 87.00 | 6.25 | | 84.5 | 7.00 | 9.03 |
| 6 | L | 250 | 1338 | −70.00 | −4.97 | 1433 | 77.5 | 1.00 | 1.31 |
| | R | | 1304 | −87.00 | −6.25 | | 75 | −5.00 | −3.23 |

Variation of Absolute Throughputs:

TABLE 7

| | | | | | | torque | | | |
|---|---|---|---|---|---|---|---|---|---|
| | | through- | torque | | | motor | | | change |
| | | put | average | change | change | current | amplitude | change | amplitude |
| no. | | [kg/h] | [Nm] | [Nm] | [%] | [Nm] | [Nm] | amplitude | [%] |
| 1 | L | 189 | 1170 | — | — | 1225.5 | 67.5 | — | — |
| | R | | 1155 | — | — | | 67.5 | — | — |
| 2 | L | 399 | 1408 | 238.00 | 20.34 | 1503 | 76.5 | 9.00 | 13.33 |
| | R | | 1391 | 236.00 | 20.43 | | 76.5 | 10.00 | 14.81 |

Measurements PET Flakes:

TABLE 8

| author | date | material | — | plant |
|---|---|---|---|---|
| P. Michels | Aug. 18, 2014 | polyethylene terephthal- | flakes | RZE 3.0 |
| | | ate (PET) | | |

Experimental Design:

TABLE 9

| | | temperature | | absolute | rotational |
|---|---|---|---|---|---|
| test | | setting | spec. throughput | throughput | speed |
| no. | screw | [° C.] | [kg*min/h] | [kg/h] | [rpm] |
| 1 | left | 285/270 | 2.74 | 460 | 168 |
| | right | | | | |
| 2 | left | 285/270 | 2.74 | 494 | 180 |
| | right | | | | |
| 3 | left | 285/270 | 2.68 | 475 | 177 |
| | right | | | | |
| 4 | left | 285/270 | 2.25 | 477 | 212 |
| | right | | | | |
| 5 | left | 285/270 | 3.28 | 469 | 143 |
| | right | | | | |
| 6 | left | 285/270 | 2.67 | 800 | 300 |
| | right | | | | |
| 7 | left | 285/270 | 2.66 | 770 | 290 |
| | right | | | | |
| 8 | left | 285/270 | 2.65 | 795 | 300 |
| | right | | | | |

Test Results Torques:

TABLE 10

| | | | spec. | | | | | | |
|---|---|---|---|---|---|---|---|---|---|
| | | | through- | abs. | | | torque | | |
| | | | put | through- | torque | motor | motor | period | period |
| | | temp. | [kg* | put | average | current | current | duration | duration |
| no. | | [° C.] | min/h] | [kg/h] | [Nm] | [%] | [Nm] | torque [s] | screw [s] |
| 1 | L | 285/270 | 2.74 | 460 | 1757 | 67 | 2043.5 | 0.175 | 0.36 |
| | R | | | | 1796 | | | 0.175 | |
| 2 | L | 285/270 | 2.74 | 494 | 1771 | 63 | 1921.5 | 0.16 | 0.33 |
| | R | | | | 1822 | | | 0.16 | |
| 3 | L | 285/270 | 2.68 | 475 | 1785 | 66 | 2013 | 0.16 | 0.34 |
| | R | | | | 1807 | | | 0.16 | |
| 4 | L | 285/270 | 2.25 | 477 | 1828 | 56 | 1693 | 0.15 | 0.28 |
| | R | | | | 2006 | | | 0.15 | |
| 5 | L | 285/270 | 3.28 | 469 | 1956 | 71 | 2165.5 | 0.21 | 0.42 |
| | R | | | | 2052 | | | 0.21 | |
| 6 | L | 285/270 | 2.67 | 800 | 1965 | 68 | 2059 | 0.09 | 0.20 |
| | R | | | | 2008 | | | 0.095 | |
| 7 | L | 285/270 | 2.66 | 770 | 1966 | 70 | 2135 | 0.09 | 0.21 |
| | R | | | | 1988 | | | 0.093 | |
| 8 | L | 285/270 | 2.65 | 795 | 1967 | 60 | 1830 | 0.107 | 0.20 |
| | R | | | | 1984 | | | 0.105 | |

Test Results Bending Moments:

TABLE 11

| | | | spec. | | | | period | period |
|---|---|---|---|---|---|---|---|---|
| | | temper- | through- | abs. | | bending | duration | dura- |
| | | ature | put | through- | bending | moment | bending | tion |
| | | setting | [kg* | put | moment | ampli- | moment | screw |
| no. | | [° C.] | min/h] | [kg/h] | [Nm] | tude | [s] | [s] |
| 1 | L | 285/270 | 2.74 | 460 | −20/−160 | 70 | 0.35 | 0.36 |
| | R | | | | +40/−60 | 50 | 0.36 | |
| 2 | L | 285/270 | 2.74 | 494 | −20/−160 | 70 | 0.33 | 0.33 |
| | R | | | | +40/−60 | 50 | 0.33 | |
| 3 | L | 285/270 | 2.68 | 475 | −20/−160 | 70 | 0.33 | 0.34 |
| | R | | | | +40/−60 | 50 | 0.33 | |
| 4 | L | 285/270 | 2.25 | 477 | −40/−180 | 70 | 0.3 | 0.28 |
| | R | | | | +40/−60 | 50 | 0.3 | |
| 5 | L | 285/270 | 3.28 | 469 | 0/−150 | 75 | 0.42 | 0.42 |
| | R | | | | +50/−60 | 55 | 0.42 | |
| 6 | L | 285/270 | 2.67 | 800 | +20/−130 | 75 | 0.19 | 0.20 |
| | R | | | | +50/−70 | 60 | 0.19 | |
| 7 | L | 285/270 | 2.66 | 770 | −20/−160 | 70 | 0.18 | 0.21 |
| | R | | | | +40/−70 | 55 | 0.19 | |
| 8 | L | 285/270 | 2.65 | 795 | −20/−160 | 70 | 0.21 | 0.20 |
| | R | | | | +40/−60 | 50 | 0.21 | |

Variation of Spec. Throughputs

TABLE 12

| | | | spec. | | | | | |
|---|---|---|---|---|---|---|---|---|
| | | temper- | through- | abs. | | | | |
| | | ature | put | through- | rotational | torque | bending | torque |
| test | | setting | [kg* | put | speed | average | moment | change |
| no. | screw | [° C.] | min/h] | [kg/h] | [rpm] | [Nm] | [Nm] | [%] |
| 4 | left | 285/270 | 2.25 | 477 | 212 | 1828 | −40/−180 | — |
| | right | | | | | 2006 | +40/−60 | — |
| 3 | left | 285/270 | 2.68 | 475 | 177 | 1785 | −20/−160 | −2.35 |
| | right | | | | | 1807 | +40/−60 | −9.92 |
| 5 | left | 285/270 | 3.28 | 469 | 143 | 1956 | 0/−150 | 7.00 |
| | right | | | | | 2052 | +50/−60 | 2.29 |

Measurements With Different Plug-In Mounts:

TABLE 13

| author | date | material | — | plant |
|---|---|---|---|---|
| P. Michels | Feb. 26, 2015 | (PET) | granulate | RZE 3.0 |

Experimental Design:

TABLE 14

| | | spec. | | | | | | | | | | | | |
|---|---|---|---|---|---|---|---|---|---|---|---|---|---|---|
| | | through- | | | | | | | | | | | | |
| | through- | put | | | | | | | | | | | | |
| test | put | [kg* | temperature profile [° C.] | | | | | | | | | | plug-in | |
| point | [kg/h] | min/h] | 1.1 | 1.2 | 1.3 | 1.4 | 1.5 | 1.6 | 1.7 | 1.8 | 1.9 | 1.10 | mount | |
| VP1 | 400 | 2.7 | 285 | 285 | 285 | 285 | 285 | 270 | 270 | 270 | 270 | 270 | (1) | 7641001 |
| VP1 | 400 | 2.7 | 285 | 285 | 285 | 285 | 285 | 270 | 270 | 270 | 270 | 270 | (2) | 7641005 |
| VP1 | 400 | 2.7 | 285 | 285 | 285 | 285 | 285 | 270 | 270 | 270 | 270 | 270 | (3) | 7641006 |
| VP2 | 600 | 2.7 | 285 | 285 | 285 | 285 | 285 | 270 | 270 | 270 | 270 | 270 | (1) | 7641001 |
| VP2 | 600 | 2.7 | 285 | 285 | 285 | 285 | 285 | 270 | 270 | 270 | 270 | 270 | (2) | 7641005 |
| VP3 | 800 | 2.7 | 285 | 285 | 285 | 285 | 285 | 270 | 270 | 270 | 270 | 270 | (1) | 7641001 |
| VP3 | 800 | 2.7 | 285 | 285 | 285 | 285 | 285 | 270 | 270 | 270 | 270 | 270 | (2) | 7641005 |
| VP4 | 1000 | 2.7 | 285 | 285 | 285 | 285 | 285 | 270 | 270 | 270 | 270 | 270 | (1) | 7641001 |

Test Results:

TABLE 15

| | | | | | bend- | | bend- |
|---|---|---|---|---|---|---|---|
| | through- | | | | ing | | ing |
| test | put | plug-in | amplitude | torque | moment | torque | moment |
| point | [kg/h] | mount | offset | R | R | L | L |
| VP1 | 400 | (1) | amplitude | 51 | 24 | 61.7 | 51.3 |
| | | 7641001 | offset | 1736.7 | 5.8 | 1697.1 | 170.9 |
| VP1 | 400 | (2) | amplitude | 24.6 | 22.2 | 44.2 | 46 |
| | | 7641005 | offset | 1781.4 | 11.9 | 1733.5 | 82.3 |
| VP1 | 400 | (3) | amplitude | 40.75 | 23.89 | 36.44 | 50.69 |
| | | 7641006 | offset | 2095.9 | 17.15 | 2069.2 | 82.3 |
| VP2 | 600 | (1) | amplitude | 44.7 | 23.7 | 50.7 | 47.7 |
| | | 7641001 | offset | 1933 | 3.2 | 1911.8 | 148.1 |
| VP2 | 600 | (2) | amplitude | 30.6 | 16.4 | 34.9 | 35.5 |
| | | 7641005 | offset | 2074.5 | 11.8 | 2040.6 | 79.4 |
| VP3 | 800 | (1) | amplitude | 38.2 | 17.6 | 44.2 | 32.9 |
| | | 7641001 | offset | 2031.5 | 5.8 | 2046.1 | 125.26 |
| VP3 | 800 | (2) | amplitude | 24.5 | 17.4 | 28.6 | 28.4 |
| | | 7641005 | offset | 2124.9 | 13.3 | 2151.3 | 144.2 |
| VP4 | 1000 | (1) | amplitude | 42.9 | 16.9 | 48 | 32.1 |
| | | 7641001 | offset | 2016.1 | 8.1 | 2059.8 | 115.2 |

Protocol on Wear Measurements:

TABLE 16

| author | date | material | — | plant |
|---|---|---|---|---|
| P. Michels | Feb. 25, 2015 | polypropylene | granulate | RZE 3.0 |
| | | (PP) MFI3 | | |

Experimental Design:

TABLE 17

| | | spec. | | | | | | | | | | | | |
|---|---|---|---|---|---|---|---|---|---|---|---|---|---|---|
| | abs. | through- | | | | | | | | | | | | |
| | through- | put | | | | | | | | | | | | |
| | put | [kg* | pressure | temperature [° C.] | | | | | | | | | | torque |
| no. | [kg/h] | min/h] | [bar] | 1.1 | 1.2 | 1.3 | 1.4 | 1.5 | 1.6 | 1.7 | 1.8 | 1.9 | 1.10 | [rpm] |
| VP1 | 400 | 2.7 | 60 | 200 | 200 | 240 | 240 | 240 | 240 | 240 | 240 | 240 | 240 | 148.1 |
| VP2 | 400 | 2.7 | 60 | 200 | 200 | 240 | 240 | 240 | 240 | 240 | 240 | 240 | 240 | 148.1 |
| VP3 | 400 | 2.3 | 60 | 200 | 200 | 240 | 240 | 240 | 240 | 240 | 240 | 240 | 240 | 173.9 |
| VP4 | 400 | 3.1 | 60 | 200 | 200 | 240 | 240 | 240 | 240 | 240 | 240 | 240 | 240 | 129.0 |
| VP5 | 400 | 2.7 | 40 | 200 | 200 | 240 | 240 | 240 | 240 | 240 | 240 | 240 | 240 | 148.1 |
| VP6 | 400 | 2.7 | 80 | 200 | 200 | 240 | 240 | 240 | 240 | 240 | 240 | 240 | 240 | 148.1 |
| VP7 | 300 | 2.7 | 60 | 200 | 200 | 240 | 240 | 240 | 240 | 240 | 240 | 240 | 240 | 111.1 |
| VP8 | 500 | 2.7 | 60 | 200 | 200 | 240 | 240 | 240 | 240 | 240 | 240 | 240 | 240 | 185.2 |

Measurement Results:

TABLE 18

| | | | | | | | | | | | deviation | | | |
|---|---|---|---|---|---|---|---|---|---|---|---|---|---|---|
| | | | | | bending | | | | bending | | between | | | |
| | | | | | moment | | torque | | moment | | test points | | | |
| | | | torque | deviation | R | deviation | L | deviation | L | deviation | T.R. | B.R. | T.L. | B.L. |
| no. | | | Nm] | [%] | [Nm] | [%] | [Nm] | [%] | [Nm] | [%] | [%] | [%] | [%] | [%] |
| 1 | amplitude | new | 65.00 | — | 8.40 | — | 73.90 | — | 43.40 | — | — | — | — | — |
| | | worn | 73.80 | 13.54 | 60.90 | 625.00 | 58.70 | −20.57 | 28.40 | −34.56 | — | — | — | — |
| | offset | new | 1828.00 | — | 14.20 | — | 1811.00 | — | 208.10 | — | — | — | — | — |
| | | worn | 1886.00 | 3.17 | 10.90 | −23.24 | 1880.00 | 3.81 | 88.90 | −57.28 | — | — | — | — |
| 2 | amplitude | new | 68.60 | — | 9.60 | — | 80.00 | — | 45.60 | — | 5.54 | 14.29 | 8.25 | 5.07 |
| | | worn | 66.30 | −3.35 | 58.50 | 509.38 | 54.00 | −32.50 | 27.70 | −39.25 | −10.1 | −3.94 | −8.01 | −2.46 |
| | offset | new | 1829.80 | — | 14.00 | — | 1805.10 | — | 205.90 | — | 0.10 | −1.41 | −0.33 | −1.06 |
| | | worn | 1871.60 | 2.28 | 11.20 | −20.00 | 1870.60 | 3.63 | 89.50 | −56.53 | −0.76 | 2.75 | −0.50 | 0.67 |
| 3 | amplitude | new | 43.40 | — | 9.30 | — | 53.40 | — | 40.00 | — | −33.23 | 10.71 | −27.74 | −7.83 |
| | | worn | 55.00 | 26.73 | 58.10 | 524.73 | 45.90 | −14.04 | 30.60 | −23.50 | −25.47 | −4.60 | −21.81 | 7.75 |
| | offset | new | 1645.70 | — | 13.00 | — | 1615.50 | — | 199.10 | — | −9.97 | −8.45 | −10.80 | −4.32 |
| | | worn | 1705.10 | 3.61 | 11.00 | −15.38 | 1692.60 | 4.77 | 87.80 | −55.90 | −9.59 | 0.92 | −9.97 | −1.24 |
| 4 | amplitude | new | 72.40 | — | 9.50 | — | 69.00 | — | 51.90 | — | 11.38 | 13.10 | 6.63 | 19.59 |
| | | worn | 72.90 | 0.69 | 55.40 | 483.16 | 62.80 | −8.99 | 25.00 | −51.83 | −1.22 | −9.03 | 6.98 | −11.97 |
| | offset | new | 2026.60 | — | 15.90 | — | 2003.70 | — | 196.10 | — | 10.86 | 11.97 | 10.64 | −5.77 |
| | | worn | 2069.40 | 2.11 | 11.90 | −25.16 | 2062.10 | 2.91 | 89.10 | −54.56 | 9.72 | 9.17 | 9.69 | 0.22 |
| 1 | amplitude | new | 57.00 | — | 11.90 | — | 66.50 | — | 50.00 | — | −12.31 | 41.67 | −10.28 | 15.21 |
| | | worn | 61.90 | 8.60 | 56.80 | 377.31 | 54.80 | −17.35 | 27.50 | −45.00 | −16.12 | −6.73 | −6.64 | −3.17 |
| | offset | new | 1805.50 | — | 12.60 | — | 1775.10 | — | 183.20 | — | −1.23 | −11.27 | −1.95 | −11.97 |
| | | worn | 1802.50 | −0.17 | 10.60 | −15.87 | 1804.30 | 1.64 | 81.40 | −55.57 | −4.43 | −2.75 | −4.03 | −8.44 |
| 2 | amplitude | new | 55.70 | — | 10.90 | — | 63.90 | — | 45.60 | — | −14.31 | 29.76 | −13.53 | 5.07 |
| | | worn | 58.40 | 4.85 | 57.20 | 424.77 | 51.70 | −19.09 | 27.80 | −40.13 | −20.87 | −6.08 | −11.93 | −3.07 |
| | offset | new | 1915.00 | — | 15.90 | — | 1882.80 | — | 194.20 | — | 4.76 | 11.97 | 3.95 | −6.68 |
| | | worn | 1922.00 | 0.37 | 11.50 | −27.67 | 1915.70 | 1.75 | 90.90 | −58.19 | 1.91 | 5.50 | 1.90 | 2.25 |
| 3 | amplitude | new | 36.50 | — | 8.30 | — | 39.10 | — | 34.40 | — | −43.85 | −1.19 | −47.09 | −20.74 |
| | | worn | 61.40 | −68.22 | 56.30 | −578.81 | 54.30 | 38.87 | 29.90 | −13.08 | −16.80 | −7.55 | −7.50 | 5.28 |
| | offset | new | 1764.60 | — | 14.00 | — | 1738.10 | — | 180.00 | — | −3.47 | −1.41 | −4.08 | −13.50 |
| | | worn | 1756.40 | −0.46 | 10.00 | −28.57 | 1758.90 | 1.20 | 84.40 | −53.11 | −6.87 | −8.26 | −6.44 | −5.05 |
| 4 | amplitude | new | — | — | — | — | — | — | — | — | — | — | — | — |
| | | worn | 50.10 | — | 47.88 | — | 46.08 | — | 23.50 | — | −32.11 | −21.38 | −21.50 | −17.25 |
| | offset | new | — | — | — | — | — | — | — | — | — | — | — | — |
| | | worn | 1930.10 | — | 11.69 | — | 1922.60 | — | 83.62 | — | 2.34 | 7.25 | 2.27 | −5.94 |

1. An extruder having a cylinder and a screw arranged therein and a drive train for the screw, the drive train having a coupling with the screw and
the extruder, having a sensor for recording a moment load comprising torque and/or bending moment and for generating electronic data from the recorded moment load,
a controller being provided which is in operative connection to a drive for the drive train,
the sensor being in data connection with the controller,
the controller being adapted to evaluate the data on the recorded moment load and to trigger a protective action if a threshold value set in the controller is exceeded, and
the evaluation including a bending moment calculation.

2. The extruder according to claim 1, wherein an averaged offset of the bending moment is calculated.

3. The extruder according to claim 1, wherein an amplitude of the bending moment is calculated.

4. An extruder comprising a double-cylinder and a double-lead screw arranged therein, as well as a drive train for the screw,
the drive train having a coupling with the screw and
the extruder, having a sensor for recording a moment load comprising torque and/or bending moment and for generating electronic data from the recorded moment load,
a controller being provided which is in operative connection to a drive for the drive train.
the sensor being in data connection with the controller,
the controller being adapted to evaluate the data on the recorded moment load and to trigger a protective action if a threshold value set in the controller is exceeded, and
the evaluation comprising a frequency calculation.

5. The extruder according to claim 4, wherein the frequency calculation comprises an amplitude calculation.

6. The extruder according to claim 4, wherein the protective action is a braking or a stopping of the drive train and/or an opening of the coupling.

7. The extruder according to claim 4, wherein the extruder has a first coupling and a second coupling between the drive train and the screw, the first coupling being arranged on the drive train side of the gear and the second coupling being disposed on the screw side of the gear.

8. The extruder according to claim 4, wherein the protective action is the output of a wear warning, with the controller offering an acknowledgement with an authorization.

9. The extruder according to claim 4, wherein several different threshold values are provided to which the controller is adapted to assign different protective actions.

10. The extruder according to claim 4, wherein the sensor has a wire strain gauge.

11. The extruder according to claim 4, wherein the sensor has an optical system

12. The extruder according to claim 4, wherein a magnetic or inductive sensor is provided.

13. The extruder according to claim 4, wherein the controller is in data connection to a database which can be updated externally.

14. The extruder according to claim 4, wherein the controller has an input interface for recording manually input geometrical measurement and/or optical values concerning the screw and/or the cylinder.

15. The extruder according to one of the above claim 4, wherein the controller has a corrective algorithm for adapting the threshold value or the parameter for calculating the threshold value using the manually input values.

16. A plastic molding plant for producing a film by means of an extruder according to claim 1 and by means of a nozzle unit and a cooling and wind-up unit; or a compounding plant with the extruder.

17. A method for operating a plant according to claim 16, the method including the following steps:
a. recording a torque and/or a bending moment in the extruder by means of a sensor;
b. transferring data on the recorded moment load to the controller; and
c. evaluating the data by means of the controller, comprising
i. a frequency calculation and/or
ii. a bending moment calculation.

18. The method according to claim 17, wherein in the calculation, data are grouped in classes.

19. The method according to claim 18, wherein the amplitude of the class is monitored.

20. The method according to claim 18, wherein for two classes, the amplitudes are computed and monitored.

21. The method according to claim 17, wherein the amplitude of at least a class around 5 Hz to 6 Hz is computed.

22. The method according claim 17, wherein the data of one frequency bandwidth are grouped in one class.

23. The method according to claim 17, wherein an offset of the bending moment is monitored for reduction so as to detect a wear of the extruder.

24. The method according to claim 17, wherein an amplitude of the bending moment is monitored for reduction so as to detect wear of the extruder.

25. The method according to claim 17, wherein the coupling is set so as to be triggered more sensitively with increasing wear.
